(19) United States
(12) Patent Application Publication
(10) Pub. No.: US 2004/0131955 A1
(43) Pub. Date: Jul. 8, 2004

(54) Method of fabricating black matrix

(76) Inventor: Tan-Ching Yen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/250,035

(22) Filed: May 30, 2003

(30) Foreign Application Priority Data
Jan. 6, 2003 (TW) 92100160

(51) Int. Cl. G02B 5/20; G02F 1/1335

(52) U.S. Cl. 430/7

(57) ABSTRACT

A method of fabricating a black matrix. A transparent substrate on which a red color block, a green color block and a blue color block are formed is provided. A black layer is formed on the substrate. The black layer is polished and planarized into a certain thickness, and the horn regions of the red, green and blue color blocks are removed to expose a top surface.

### CROSS REFERENCE TO RELATED APPLICATIONS

This application claims the priority benefit of Taiwan application Serial no. 92100160, filed Jan. 06, 2003.

### BACKGROUND OF INVENTION

1. Field of the Invention

The present invention relates in general to a method of fabricating a color filter, and more particularly, to a method of fabricating a black matrix (BM).

2. Description of the Related Art

Liquid crystal display (LCD) has dominated the market over the conventional cathode ray tube (CTR) due to the characteristics of low operation voltage, non-radiation scattering, light weight and small volume. In the recent years, liquid crystal display has become a major research area and has developed towards the objective of full color display.

Currently, the color liquid crystal display normally uses the combination of a backlight (BL) and a color filter to obtain full color effect. The structure of the color filter is illustrated in FIG. 1.

FIG. 1 shows a cross sectional view of a color filter. Referring to FIG. 1, a red color block 102, a green color block 104 and a blue color block 106 are arranged on a transparent substrate 100. A black matrix 108 is disposed between the color blocks 102, 104 and 106, and horn regions 107 are consequently formed on the green color block 104 and the blue color block 106. That is, the top surfaces of the green color block 104 and the blue color block 106 resulted with the geometry of a recessed center and a spiking edge. In addition, an indium tin oxide (ITO) transparent electrode 110 is formed on the substrate 100, and an overcoat (OC) 112 is formed between the transparent electrode 110 and the substrate 100 to cover the color blocks 102, 104, 106 and the black matrix 108.

The above method for fabricating the color filter includes coating a black photosensitive resin material on the glass substrate 100, followed by the photolithography process including exposure, development, hard back to form the black matrix 108. By the same photolithography process, the red (R), green (G) and blue (B) color blocks 102, 104 and 106 are formed with uniform space in the openings 114 formed by the black matrix 108. The overcoat 112 is then formed over the substrate 100, and the indium tin oxide transparent electrode 110 is deposited on the substrate 100 to complete the process of fabricating the color filter.

However, as the adhesion of the photosensitive resin is variable with the processing time in the conventional color filter fabrication process, the spin-coating speed has to be adjusted to obtain the required film thickness. In addition, as the response speed of the liquid crystal display is continuously increased, the demand on the planarity of the color filter is consequently increased. However, without removing the horn regions at the overlap between the color blocks and the black matrix, an overcoat is required. Therefore, the chromatic aberration between RGB cannot be predicted, and the process complexity is increased.

In addition, the line width of the black matrix of the color filter is directly related to the opening ratio of the liquid crystal display. By increasing the opening ratio, the photo-efficiency of the liquid crystal display is enhanced. Consequently, the power consumption is lowered. However, by compromising the alignment precision of the black matrix and the color blocks in the process and avoiding degradation of overall planarity of the color filter caused by overlap of color blocks, the line width of the black matrix of the conventional color filter is limited over 12 microns. Therefore, the opening ratio cannot be increased.

### SUMMARY OF INVENTION

The present invention provides a method of fabricating a black matrix of which the thickness is easily controlled.

The present invention also provides a method of fabricating a black matrix that can remove the horn regions at the overlap between the color blocks and the black matrix.

The present invention further provides a method of fabricating a black matrix to avoid RGB chromatic aberration.

The opening ratio is enhanced by the method of fabricating a black matrix provided by the invention.

The method of fabricating a black matrix provided by the present invention improves the overall planarity of the color filter without increasing process complexity.

The residue of photosensitive resin on the black matrix, the red color block, the green color block, the blue color block and the substrate can be completely removed to broaden the process windows.

In the method of fabricating a black matrix provided by the present invention, a transparent substrate comprising a red color block, a green color block and a blue color block thereon is provided. A black layer is formed on the substrate. A color filter polishing method (CFP) is performed to planarize the black layer, so as to remove the horn regions of the color blocks, such that the top surfaces thereof are exposed.

The present invention further provides a method of fabricating a color filter. A red color block, a green color block and a blue color block are formed on a transparent substrate. A black layer is formed to cover the red, green and blue color blocks. The black layer is planarized to a predetermined thickness using polishing, for example, so as to expose the top surfaces of the red, green, and blue blocks. A transparent electrode is then formed on the red, green and blue color blocks.

The present invention uses color filter polishing to fabricate the black matrix, such that the residue of photosensitive resin on the black matrix, the red, green and blue color blocks and the substrate can be thoroughly removed. Therefore, the processing window is enlarged. In addition, the color filter polishing process improves the uneven surface of the color filter. Further, the present invention does not require an overcoat covering the red, green and blue color blocks, while the chromatic aberration between the red, green and blue color blocks is avoided. Thereby, the irradiance and brightness of the color filter are enhanced.

In addition, by using the color filter polishing process, one does not have to consider the processing limits of the conventional technique, such that the line width of the black matrix is greatly reduced, and the opening ratio of the liquid crystal display is effectively increased. Further, using the color filter polishing process achieves the global planarity of the color filter without increasing the complexity of process.

### BRIEF DESCRIPTION OF DRAWINGS

The above objects and advantages of the present invention will be become more apparent by describing in detail exemplary embodiments thereof with reference to the attached drawings.

FIG. 1 shows a cross-sectional view of a conventional color filter.

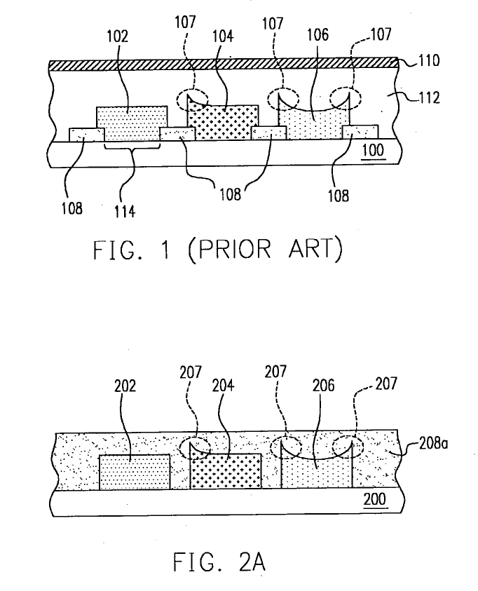

FIGS. 2A to 2C are cross-sectional views showing the fabrication process of a color filter according to the present invention.

### DETAILED DESCRIPTION

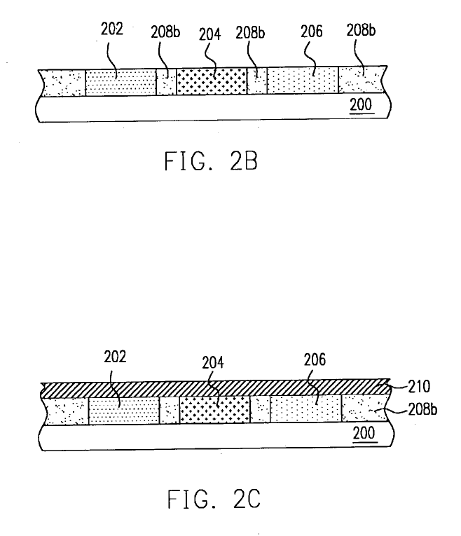

The present invention provides a method of fabricating a color filter as shown in FIGS. 2A to 2C. Though the drawings show three color blocks only, the present invention can be applied to a color filter with a number of color blocks much more than three, while the arrangement of the color blocks include mosaic, strip, rectangle or triangle, for example. The present invention is not limited to any particular type of color filter.

FIGS. 2A to 2C shows the fabrication process of a color filter according to one embodiment of the present invention. Referring to FIG. 2A, a transparent substrate 200 such as a glass substrate is provided. A red color block 202, a green color block 204, and a blue color block 206 are formed on the transparent substrate 200. A cleaning step such as brushing can be performed after the red, green and blue color blocks 202, 204 and 206 are formed. A photosensitive material is coated on the substrate 200 comprising the color blocks 202, 204 and 206. A pre-bake process is performed, followed by using a photo mask to perform exposure, development and hard back processes for forming each of the color blocks 202, 204 and 206. Meanwhile, the horn region 207 is formed on the top surfaces of the color blocks 204 and 206. That is, the top surfaces of the green color block 204 and the blue color block 206 are recessed at the center with spike edges.

Further referring to FIG. 2A, a black layer 208a is formed to cover the red, green and blue color blocks 202, 204 and 206. A black photosensitive material is coated on the substrate 200, followed by a pre-bake process. Global exposure, development and hard back are then performed.

Referring to FIG. 2B, a color filter polishing method is performed to planarize the black layer 208a into a black matrix 208b, so as to remove the horn region 207 formed on the green and blue color blocks 204 and 206. As a result, the top surfaces of the red, green and blue color blocks 202, 204 and 206 are exposed. The present invention thus removes the horn regions which cannot be removed by the conventional process; and therefore, an overcoat is not required, and the RGB chromatic aberration is avoided. The irradiance and brightness of the color filter is thus enhanced. Further, the line width of the black matrix 208b is significantly reduced compared to the black matrix 108 made by the conventional process, so that the opening ratio of the liquid crystal display is greatly enhanced.

Referring to FIG. 2C, a transparent electrode 210 is formed on the red, green and blue color blocks 202, 204 and 206. The material of the transparent electrode 210 includes indium tin oxide, indium zinc oxide, for example. The method for forming the transparent electrode 210 includes physical vapor deposition (PVD) or sputtering deposition, for example.

The present invention can at least be characterized in the following ways.

1. The process is simplified and the photosensitive resin on the black matrix, the red, green and blue color blocks, and the substrate can be completely removed by using color filter polishing. As a result, the processing window is widened.

2. The uneven surface of the color filter is improved by using color filter polishing. Therefore, an overcoat is not required to cover the color blocks. Meanwhile, the color aberration between the red, green and blue color blocks is avoided, such that the irradiance and brightness of the color filter are enhanced.

3. In the color filter polishing process, the processing limits of the conventional technique are not considered, such that the line width of the black matrix is greatly reduced, while the opening ratio of the liquid crystal display is effectively increased.

4. Without increasing the process complexity, the global planarity of the color filter can be enhanced by using the color filter polishing process.

While the present invention has been particularly shown and described with reference to preferred embodiments thereof, it will be understood by those of ordinary skill in the art that various changes in form and details may be made therein without departing from the spirit and scope of the present invention as defined by the appended claims.

1. A method of fabricating a black matrix, suitable for performing on a transparent substrate with a red color block, a green color block, and a blue color block formed thereon, the method comprising:
forming a black layer on the transparent substrate; and
performing color filter polishing to planarize the black layer until the top surfaces of the red, green and blue color blocks are exposed.

2. The method as claimed in claim 1, wherein the step of forming the black layer comprises:
coating a black photosensitive material on the transparent substrate; and
performing hard bake.

3. The method as claimed in claim 2 wherein the step of coating a black photosensitive material further comprises:
performing pre-bake;
performing global exposure; and
performing development.

4. The method as claimed in claim 1, wherein the transparent substrate comprises a glass substrate.

5. A method of fabricating a color filter, comprising:
forming a plurality of red color blocks;
forming a plurality of green color blocks;
forming a plurality of blue color blocks;
forming a plurality of black layers to cover the red, green and blue color blocks;
planarizing the black layers to form a plurality of black matrices; and
forming a transparent electrode on the red, green, and blue color blocks.

6. The method as claimed in claim 5, wherein the step of planarizing the black layers comprises a step of color filter polishing.

7. The method as claimed in claim 5, wherein the step of forming the black layers comprises:
coating a black photosensitive resin material on the transparent substrate, and
performing hard bake.

8. The method as claimed in claim 7, wherein the step of coating the black layers further comprises:
performing pre-bake;
performing global exposure; and
performing development.

9. The method as claimed in claim 5, wherein the step of forming the red color blocks comprises:
coating a red photosensitive material on the transparent substrate;
using a photo mask to perform exposure;
performing development; and
performing hard bake.

10. The method as claimed in claim 9, further comprising a step of pre-bake after coating the red photosensitive material on the transparent substrate.

11. The method as claimed in claim 5, wherein the step of forming the green color blocks comprises:
coating a green photosensitive material on the transparent substrate;
using a photo mask to perform exposure;
performing development; and
performing hard bake.

12. The method as claimed in claim 11, further comprising a step of pre-bake after coating the green photosensitive material on the transparent substrate.

13. The method as claimed in claim 5, wherein the step of forming the blue color blocks comprises:
coating a blue photosensitive material on the transparent substrate;
using a photo mask to perform exposure;
performing development; and
performing hard bake.

14. The method as claimed in claim 13, further comprising a step of pre-bake after coating the blue photosensitive material on the transparent substrate.

15. The method as claimed in claim 5, wherein the transparent electrode is made of indium tin oxide or indium zinc oxide.

16. The method as claimed in claim 5, wherein the step of forming the transparent electrode comprises physical vapor deposition.

17. The method as claimed in claim 16, wherein the physical vapor deposition comprises sputtering deposition.
